(19) United States
(12) Patent Application Publication
(10) Pub. No.: US 2001/0020052 A1
(43) Pub. Date: Sep. 6, 2001

(54) Dental isolation material, an application, a dental kit, two additional methods for making a prosthesis, a use for the isolation material, a prosthesis, an additional method for making a prosthesis, and a additional applications of the isolation material

(76) Inventors: Albert Erdrich, Bad Nauheim (DE); Frank Stange, Usingen (DE); Novica Savic, Wehrheim (DE); Bettina Korthaus, Schmitten (DE)

Correspondence Address: Kurt G. Briscoe, Esq., Norris McLaughlin & Marcus, P.A., 220 East 42nd Street - 30th Floor, New York, NY, 10017, US

(21) Appl. No.: 09/731,506

(22) Filed: Dec. 7, 2000

(30) Foreign Application Priority Data
Dec. 9, 1999 (DE) 199 59 255.1

(51) Int. Cl. A01N 1/00; C08K 3/00; C08K 5/07; C08K 5/05

(52) U.S. Cl. 523/112; 523/115; 524/356; 524/379

(57) ABSTRACT

A dental isolation material, among other things, is proposed, containing:

10-60 weight-% water

30-85 weight-% C₂-C₄ alcohol

2-10 weight-% polyvinyl alcohol, and

0-30 weight-% acetone.

The invention relates to a dental isolation material, an application, a dental kit, two additional methods for making a prosthesis, a use for the isolation material, a prosthesis, an additional method for making a prosthesis, and additional applications of the isolation material of the invention.

In DE 299 20 415 U1, a dental interspace varnish is disclosed, which is characterized in that it is applied as a spacer film on dental model parts, remains soluble in water after drying and hardening and remains removable with water without the aid of an organic solvent because the lacquer binding agent is an organic chemical macromolecule which dries reversibly in a film-like manner and/or is reversibly swellable or reversibly soluble in a hydrophilic medium, its principal chain having a polyvinyl or cellulosic structure.

In JP 0004075652 AA a separating agent is described which may contain polyvinyl alcohol and a solvent—water or acetone for example.

GB 484 343 A describes the use of polyvinyl alcohol as a separating agent in the making of prostheses.

In DE 198 48 886 A1 a photopolymerizable single-component dental material is described, containing:

a) 80-10 wt.-% of at least one polyfunctional urethane methacrylate and/or at least one polyfunctional urethane acrylate,

b) 10-30 wt.-% of at least one polyfunctional acrylate resin,

c) 10-30 wt.-% of at least one reactive diluent,

d) 0-20 wt.-% of bis-GMA and/or at least one ethoxylated bisphenol-A-dimethacrylate.

e) 0-10 wt.-% of at least one filler,

f) 0-1 wt.-% of at least one photoinitiator system, and

g) 0-1 wt.-% of at least one pigment.

GB 1 113 722 A shows a composition on an acrylate basis which is polymerizable under atmospheric conditions.

GB 916 075 A shows a method for the production of a cast composite article of polymerized methylmethacrylate resin.

In dental technology a number of traditional methods are known for making prostheses.

For one thing, what is involved is the investment of a trial fitting in plaster of Paris in which the plaster is mixed with water and poured over the trial fitting placed in a flask. After the plaster sets the wax is melted out and the plaster surfaces are insulated with alginate. The cavity thus formed can then be filled with thermally or chemically initiated plastic by the injection method, pouring method or ramming method and the material can be polymerized by various methods. A disadvantage in this method is the relatively great amount of time involved, and the fact that no optical control is possible to determine whether the flask has been completely emptied. It is furthermore disadvantageous that no photosetting materials can be used. Disadvantageously, in this process the plaster can dry out, resulting in volume changes (shrinkage), and furthermore moisture remaining in the plaster can cause discoloration of the plastic, and in general isolation with alginate is necessary.

Another method is the investment of the trial fitting in hydrocolloid, in which the hydrocolloid material or also agar-agar is liquefied by heating to temperatures above +50° C., and is then poured over the trial fitting in a flask. After the material has cooled and solidified the wax is removed and the resultant cavity is filled with a 2-K autopolymer by the pouring method. The two components of the autopolymer react to mixing by hardening and form the desired raw prosthesis shape. A disadvantage of this method is the fact that it is prone to error in which special flasks are necessary and, in general, poor elastic impression accuracy is found, while no polymerization is possible above 50° C. This method is suitable only for use with very fluid casting plastics which results in greater shrinkage after polymerization.

Lastly, the use of rim silicone in partial prosthetic work such as fill-ins, in which silicone is modeled vestibularly onto the trial fitting, cured on the model and the teeth are thus fixed in position. Thereafter casting plastic can be poured through the half-side opening and polymerized. A disadvantage in this method is the fact that the silicone must be prepared from base and hardener, and errors in the mixing ratios often result in deficient curing. Silicones which set by condensation used for this purpose are not transparent, but they can be hand-mixed. Suitable silicones which crosslink by addition are transparent, but cannot be hand-mixed on account of their stickiness.

Silicones which are especially easy to set by condensation are subject to a shrinkage process because they yield water, which can lead to misfits in the prosthesis. Furthermore, the time the silicones require for setting until they are usable amounts to as much as 10 minutes, and furthermore the teeth must be fixed in the silicone by cementing them with wax or with adhesives containing cyanoacrylate.

The isolation of plaster surfaces from the working model base is performed as a rule with alginates. The alginates are crosslinked by contact with the calcium ions contained in the plaster and thus form a film on the surface of the plaster. It is disadvantageous that this isolation can be performed only on plaster surfaces, since no wetting occurs on plastic surfaces and dripping occurs. Lastly, stubborn problems arise regarding the setting process which result in obvious quality defects on the plastic.

Furthermore, isolation with oil-wax-paraffin-resin solutions is possible. In this case a film is produced on the surface. In the case of silicone oils the film can be fluid and with paraffins it can be solid. With solid film-forming agents such as waxes and paraffins the use of a solvent is necessary. A disadvantage of this kind of isolation is the fact that liquid separating agents form a lubricant film that flows easily and can be wiped off by contact. Furthermore, wetting problems can occur and also quality problems due to interactions with the organic plastic. Solid film forming separating agents are usually dissolved in organic solvents. For example, alkanes such as hexane or also benzines, as well as alcohols and esters and aromatic solvents are used. These are easily volatile and evaporate very rapidly in air. Since in many cases they contain a potential toxicological hazard their use is permissible only in well ventilated areas, since they have a very bad odor. It is furthermore disadvantageous that residues of solvents have an effect on the quality of the material later applied to them. The parting coatings often have an irregular thickness and an adverse effect on elastic impression accuracy, especially in areas in which a large amount of separating agent has been applied (puddling). Lastly, it is disadvantageous that the formation of a crosslinked film does not take place, so that the film has no great resistance to external influences.

For the above reasons the problem arises of at least partially eliminating these disadvantages by means of a novel dental isolation material. The problem consists especially in producing a dental isolation material which will assure optimum elastic impression and fitting accuracy combined with advantageous material and handling characteristics of an investment material and permit the finished prosthesis to be deflasked without damage to its surface.

This problem is solved according to the invention by a dental isolation material according to claim 1, a dental kit according to claim 5, methods according to claims 16 to 17, an application according to claim 29, a prosthesis according to claim 30, and uses according to claims 42 to 44.

The dental isolation material according to the invention contains 10-60 wt.-% water, 30-85 wt.-% C₂-C₄ alcohol, 2-10 wt.-% polyvinyl alcohol and 0-30 wt.-% acetone. The dental isolation material according to the invention has excellent film-forming properties when brushed on. This is accompanied by rapid drying after application. It is thus possible to achieve very thin coatings on an individual flask or rim, resulting in great elastic impression accuracy when the individual flask or rim is filled with a prosthesis plastic. Lastly, the dental isolation material according to the invention is non soluble in a monomer and thus has excellent separating properties.

It is furthermore advantageous if the dental isolation material contains 40-50 wt.-% water, 45-55 wt.-% C₂-C₄ alcohol, 3-8 wt.-% polyvinyl alcohol and 0-5 wt.-% acetone, since this composition offers especially balanced properties.

The following embodiments have proven advantageous in practice:

The C₂-C₄ alcohol is ethanol.

The polyvinyl alcohol has a molecular mass of >60,000 g/mol.

The use of polyvinyl alcohol as a component in the dental isolation material of the invention will lead as a rule to excellent film forming and good separating properties.

A dental kit according to the invention contains at least one isolation material according to the invention.

The following embodiments are advantageous since they have proven good in practice:

A transparent dental investment material is used, which contains the following:

10-30 wt.-% polyethylene glycol dimethacrylate,

40-55 wt.-% polymethyl methacrylate,

5-15 wt.-% highly disperse silicon dioxide,

<1 wt.-% photoinitiators, stabilizers,

0-10 wt.-% polyethylene glycol, and

10-30 wt.-% of at least one compound from the group: urethane dimethacrylate, bis-GMA, ethoxylated bis-GMA.

A transparent dental investment material is used, which contains the following:

15-20 wt.-% polyethylene glycol dimethacrylate,

50 wt.-% polymethyl methacrylate

10-15 wt.-% at least one compound from the group: urethane dimethacrylate, bis-GMA, ethoxylated bis-GMA,

10-13 wt.-% highly disperse silicon dioxide,

0.4-0.6 wt.-% photoinitiators, stabilizers, and

5-10 wt.-% polyethylene glycol.

The polyethylene glycol dimethacrylate has a molecular mass >500 g/mol.

The polyethylene glycol dimethacrylate is solid at a temperature of about T=+20° C.

The polymethyl methacrylate has a molecular mass >160,000, an average grain size of 80-140 μm and a benzoyl peroxide content <0.1 wt.-%.

The polymethyl methacrylate is a copolymer which has been prepared with up to 10 wt.-% comonomers.

The polyethylene glycol is liquid at a temperature of about T=+20° C. and has an average molecular mass of >=200 g/mol.

The urethane dimethacrylate has a minimum molecular mass of about 450 g/mol.

The polymethyl methacrylate is in the form of a suspension polymer.

A dental material which can be cured by electromagnetic radiation is used as dental plastic.

This also applies to a method for producing a prosthesis wherein at least one isolating material according to the invent is (also) used.

The statements made regarding the dental kilt are advantageous also in the method of the invention for producing a prosthesis, since they have proven good in practice.

In an additional method according to the invention for the production of a prosthesis, first for the construction of an individual flask or rim by means of an investment material, a trial fitting is embedded, the investment material is cured by electromagnetic radiation, then the inside of the polymerized investment material, that is to say the individual flask or rim is coated, and then the individual flask or rim is filled with a prosthesis plastic. Lastly, the prosthesis is deflasked by shattering the investment material.

Here, again, the superior properties of the isolation material of the invention can be seen.

Advantageously, a dental material which can be cured by electromagnetic radiation is used as the dental plastic, especially the single-component photopolymerizing dental material disclosed in DE 198 48 886, since thus a controlled curing can be performed by exposure to controlled electromagnetic radiation, especially light and/or ultraviolet radiation.

In the method of the invention it is lastly advantageous if after the investment and before the coating operation, retainers are installed in order thus to achieve a very precise and natural positioning of the individual teeth with respect to one another.

The use of an isolation material of the invention for the production of a full or partial denture has the above-stated advantages, especially the precise and natural positioning of the individual teeth in relation to one another.

The following are given as uses of the isolation material of the invention which have proven useful in practice:

Isolation against dentin in the direct impression of inlays in the mouth by means of modeling plastics.

Isolation against plaster of Paris in modeling work for inlays, onlays or crowns.

Protection of polymerized plastic against unpolymerized material in the case of restorations or repairs, especially for the avoidance of crazing on prosthetic teeth by monomers.

Advantages and characteristic properties of the isolation material according to the invention are:

Good film forming properties when brushed on, fast drying after application, high deflasking accuracy due to thinness of coatings, good separation properties due to monomer insolubility, great transparency and permeability to light, and easy removal of residues due to solubility in water.

Even in the case of powder and liquid systems that are to be mixed up normally a reliable separation of plastic from plastic can be assured. Therefore it is suitable for use with traditional casting materials.

The following example serves to explain the invention:

On a plaster of Paris base the work is set up in wax with teeth by the standard method. The plaster base is provided with retaining means (chamfers, grooves or pins). The “individual flask material” is applied over the trial fitting. 2 to 3 pouring openings are created on the back. Then polymerization is performed with a photopolymerizing apparatus. The wax is melted out and the mold interior is treated with isolation liquid. After dry-out the teeth held in the flask material can be normally conditioned. Then the flask top and the plaster base are again carefully adapted and fixed with adhesive wax, for example. Then the casting plastic can be poured in and polymerized as required by the nature of the material. Deflasking is performed by breaking up the individual flask.

With the use of transparent silicone:

The combination of a carrier (e.g., of photosetting methacrylate, the above investment material for example, or thermoplastic) with a layer of silicone is possible. In this case the silicone is applied to the trial fitting and curing is awaited. Then an adhesive system and the support material, for example the photosetting methacrylate system, is applied. The rest of the process is then performed as described above.

| Investment material (flask material): | | | |
|---|---|---|---|
| Urethane dimethacrylate Plex 6661 | Röhm | 12.5 | wt.-% |
| Polyethylene glycol-1000-dimethacrylate | Röhm | 18.2 | wt.-% |
| Polyethylene glycol 200 | Adrich | 7.8 | wt.-% |
| C-13 Methacrylic acid ester | Röhm | 1.9 | wt.-% |
| Aerosil R974 | Degussa | 9.0 | wt.-% |
| Aerosil 380 | Degussa | 2.0 | wt.-% |
| PMMA suspension polymer M 286 | Röhm | 48.0 | wt.-% |
| Lucirin TPO | BASF | 0.6 | wt.-% |
| Isolation material: | | | |
| Polyvinyl alcohol 100000 | Fluka | 5.0 | wt.-% |
| Deionized water | Kulzer | 45.0 | wt.-% |
| ethanol | Brenntag | 50.0 | wt.-% |
| Silicones: | | | |
| Crosslinking polyvinylsiloxane | | | |
| Memosil CD | HKKG | 100 | wt.-% |

1. Dental isolation material, containing:
10-60 wt.-% water
30-85 wt.-% _{C2-C4} alcohol
2-10 wt.-% polyvinyl alcohol and
0-30 wt.-% acetone

2. Dental isolation material according to claim 1, containing:
40-50 wt.-% water
45-55 wt.-% C₂-C₄ alcohol
3-8 wt.-% polyvinyl alcohol
0 1 5 wt.-% acetone

3. Dental isolation material according to either one of claims 1 and 2, characterized in that the C₂-C₄ alcohol is ethanol.

4. Dental isolation material according to any one of claims 1 to 3, characterized in that the polyvinyl alcohol has a molecular mass greater than 60,000 g/mol.

5. Dental kit, containing at least one isolating material according to any one of claims 1 to 4.

6. Dental kit according to claim 5, characterized in that a transparent dental investment material is used, containing:
10-30 wt.-% polyethylene glycol dimethacrylate,
40-55 wt.-% polymethyl methacrylate,
5-15 wt.-% highly disperse silicon dioxide
<1 wt.-% photoinitiators, stabilizers,
0-10 wt.-% polyethylene glycol and
10-30 wt.-% of at least one compound from the group: urethane dimethacrylate, bis-GMA, ethoxylated bis-GMA.

7. Dental kit according to either one of claims 5 and 6, characterized in that a transparent dental investment material is used, containing:
15-20 wt.-% polyethylene glycol dimethacrylate,
50 wt.-% polymethyl methacrylate
10-13 wt.-% of at least one compound from the group, urethane dimethacrylate, bis-GMA, ethoxylated bis-GMA.
10 wt.-% highly disperse silicon dioxide,
0.4-0.6 wt.-% photoinitiators, stabilizers and
5-10 wt.-% polyethylene glycol.

8. Dental kit according to either one of claims 6 to 7, characterized in that the polyethylene glycol dimethacrylate has a molecular mass greater than 500 g/mol.

9. Dental kit according to any one of claims 6 to 8, characterized in that the polyethylene glycol dimethacrylate is solid at a temperature of approximately T=+20° C.

10. Dental kit according to any one of claims 6 to 9, characterized in that the polymethyl methacrylate has a molecular mass greater than 160,000, an average grain size of 80-140 μm and a benzoyl peroxide content less than 0.1 wt.-%.

11. Dental kit according to any one of claims 6 to 10, characterized in that the polymethyl methacrylate is a copolymer which has been made with up to 10 wt.-% of comonomers.

12. Dental kit according to any one of claims 6 to 11, characterized in that the polyethylene glycol is fluid at a temperature of approximately T=+20° C. and has an average molecular mass of ≧200 g/mol.

13. Dental kit according to any one of claims 6 to 12, characterized in that the urethane dimethacrylate has a minimum molecular mass at the level of 450 g/mol.

14. Dental kit according to any one of claims 6 to 13, characterized in that the polymethyl methacrylate is in the form of suspension polymerizate.

15. Dental kit according to any one of claims 6 to 14, characterized in that a dental material hardenable by electromagnetic radiation is used as dental plastic.

16. Method for making a prosthesis, characterized in that at least one isolation material according to any one of claims 1 to 4 is used.

17. Method for making a prosthesis by the following steps:
a.) Overmodeling a dental trial fitting with an investment material to create an individual flask or rim.
b) Curing the investment material by electromagnetic radiation,
c) Coating the inside of the polymerized investment material with an isolating material according to any one of claims 1 to 4,
d) Pouring a dental plastic into the individual flask or rim and
e) Deflasking by shattering the investment material.

18. Method according to any one of claims 16 to 17, characterized in that a transparent dental investment material is used, containing:
10-30 wt.-% polyethylene glycol dimethacrylate,
40-55 wt.-% polymethyl methacrylate,
5-15 wt.-% highly disperse silicon dioxide,
<1 wt.-% photoinitiators, stabilizers,
0-10 wt.-% polyethylene glycol and
10-30 wt.-% of at least one compound from the group urethane dimethcrylate, bis-GMA, ethoxylated bis-GMA,

19. Method according to any one of claims 16 to 18, characterized in that a transparent investment material is used, containing:
15-20 wt.-% polyethylene glycol dimethacrylate,
50 wt.-% polymethyl methacrylate
10-15 wt.-% at least one compound from the group: urethane dimethacrylate, bis-GMA, ethoxylated bis-GMA,
10-13 wt.-% highly disperse silicon dioxide,
0.4-0.6 wt.-% photoinitiators, stabilizers, and
5-10 wt.-% polyethylene glycol.

20. Method according to any one of claims 17 to 19, characterized in that the polyethylene glycol dimethacrylate has a molecular mass >500 g/mol.

21. Method according to any one of claims 17 to 20, characterized in that the polyethylene glycol dimethacrylate is solid at a temperature of approximately T=+20° C.

22. Method according to any one of claims 17 to 21, characterized in that the polymethylene methacrylate has a molecular mass of >160,000, an average grain size of 80-140 μm and a benzoyl peroxide content <0.1 wt.-%.

23. Method according to any one of claims 17 to 22, characterized in that the polymethyl methacrylate is a copolymer which has been made with up to 20 wt.-% comonomers.

24. Method according to any one of claims 17 to 23, characterized in that the polyethylene glycol is fluid at a temperature of approximately T=+20° C. and has an average molecular mass of ≧200 g/mol.

25. Method according to any one of claims 17 to 24, characterized in that the urethane dimethacrylate has a minimum molecular mass at the level of 450 g/mol.

26. Method according to any one of claims 17 to 25, characterized in that the polymethyl methacrylate is in the form of suspension polymerizate.

27. Method according to any one of claims 17 to 26, characterized in that a dental material curable by means of electromagnetic radiation is used as dental plastic.

28. Method according to any one of claims 17 to 27, characterized in that retentions are set up after carving and before coating.

29. Use of an isolating material according to any one of claims 1 to 4 for making a total or partial prosthesis.

30. Prosthesis, characterized in that it is made by a method of claims 16 to 28.

31. Method for making a prosthesis, characterized in that at least one isolating material according to any one of claims 1 to 4 is used, and at least one investment material containing:
10-30 wt.-% polyethylene glycol dimethacrylate,
40-55 wt.-% polymethyl methacrylate,
5-15 wt.-% highly disperse silicon dioxide
<1 wt.-% photoinitiators, stabilizers,
0-10 wt.-% polyethylene glycol and
10-30 wt.-% of at least one compound from the group: urethane dimethacrylate, bis-GMA, ethoxylated bis-GMA.

32. Method according to claim 31, characterized in that a transparent dental investment material is used, containing:
15-20 wt.-% polyethylene glycol dimethacrylate,
50 wt.-% polymethyl methacrylate
10-15 wt.-% at least one compound from the group: urethane dimethacrylate, bis-GMA, ethoxylated bis-GMA,
10-13 wt.-% highly disperse silicon dioxide,
0.4-0.6 wt.-% photoinitiators, stabilizers, and
5-10 wt.-% polyethylene glycol.

33. Method according to either one of claims 31 and 32, characterized in that the polyethylene glycol dimethacrylate has a molecular mass >500 g/mol.

34. Method according to any one of claims 31 to 33, characterized in that the polyethylene glycol dimethacrylate is solid at a temperature of approximately T=+20° C.

35. Method according to any one of claims 31 to 34, characterized in that the polymethyl methacrylate has a molecular mass of >160,000, an average grain size of 80-140 μm and a benzoyl peroxide content <0.1 wt.-%.

36. Method according to any one of claims 31 to 35, characterized in that the polymethyl methacrylate is a copolymer which has been made with up to 10 wt.-% comonomers.

37. Method according to any one of claims 31 to 36, characterized in that the polyethylene glycol is fluid at a temperature of approximately T=+20° C. and has an average molecular mass of ≧200 g/mol.

38. Method according to any one of claims 31 to 37, characterized in that the urethane dimethacrylate has a minimum molar mass at the level of 450 g/mol.

39. Method according to any one of claims 31 to 38, characterized in that the polymethyl methacrylate is in the form of a suspension polymerizate.

40. Method according to any one of claims 31 to 39, characterized in that a dental material curable by means of electromagnetic radiation is used as dental plastic.

41. Method according to any one of claims 31 to 40, characterized in that retentions are set up after the overmodeling and before the coating.

42. Use of an isolation material according to any one of claims 1 to 4 as isolation against dentin in the direct making of impressions for inlays by means of carving plastics in the mouth.

43. Use of an isolation material according to any one of claims 1 to 4 as isolation against plaster of Paris in carving work for inlays, onlays or crowns.

44. Use of an isolation material according to any one of claims 1 to 4 as protection for polymerized plastic against unpolymerized material in add-ons or repairs, especially for the avoidance of crazing on prosthesis teeth by monomers.
